(19) United States
(12) Patent Application Publication
(10) Pub. No.: US 2003/0016450 A1
(43) Pub. Date: Jan. 23, 2003

(54) Laser radiation source for generating a working beam

(75) Inventors: Veit Bluemel, Jena (DE); Klaus-Peter Stolberg, Jena (DE)

Correspondence Address: Gerald H. Kiel, Esq., REED SMITH, LLP, 375 Park Avenue, New York, NY, 10152-1799, US

(73) Assignee: Jena-Laserdiode GmbH

(21) Appl. No.: 10/200,928

(22) Filed: Jul. 22, 2002

(30) Foreign Application Priority Data
Jul. 23, 2001 (DE) 101 36 611.6

(51) Int. Cl. H01S 3/08; B23K 26/00; G02B 27/10

(52) U.S. Cl. 359/618; 372/108; 219/121.6

(57) ABSTRACT

In a laser radiation source for generating a working beam, it is the object of the invention to generate a working beam with different beam geometries, but preferably with a rectangular or line-shaped beam cross section, from overlapping laser beam bundles of a diode laser bar in a highly efficient manner using simple means, which working beam has an improved intensity distribution with respect to homogeneity and edge steepness and which ensures that a plurality of working beams can be arranged in rows for generating an elongated beam profile. In particular, a uniform intensity distribution which is free from interference should be present in areas which adjoin one another. Reflection planes extending adjacent to one another in a direction vertical to a common plane of the active layers of the emitter elements of a laser diode arrangement are provided between reflecting side surfaces of a homogenization element, and the laser beam bundles pass through these reflection planes one after the other. Due to the divergence of the laser beam bundles in a direction parallel to the common plane, the reflections between the side surfaces repeat in every reflection plane.

### CROSS-REFERENCE TO RELATED APPLICATION

This application claims priority of German Application No. 101 36 611.6, filed Jul. 23, 2001, the complete disclosures of which are hereby incorporated by reference.

### BACKGROUND OF THE INVENTION

a) Field of the Invention

The invention is directed to a laser radiation source for generating a working beam in which emitter elements of a laser diode arrangement which emit laser beam bundles are arranged adjacent to one another with their active layers in a common plane and spatially separated in a first coordinate direction, comprising collimating optics acting in a second coordinate direction vertical to the common plane of the active layers of the emitter elements and a homogenization element with a pair of reflecting side surfaces facing one another.

b) Description of the Related Art

Increasingly, continually broader fields of application in industry and medical technology are opening up for high-power diode lasers in the form of diode laser bars because they represent a good alternative to other radiation sources and tools due to their high electro-optic efficiency, economical manufacture and compact construction.

However, as is well known, the output radiation of diode laser bars has its peculiar characteristics which must be adapted for most applications by optics with different actions. This is usually accomplished in that the radiation, which has great differences in divergence angle in a plane vertical to the active layer (fast axis or y-axis) and in the plane of the active layer (slow axis or x-axis), is initially collimated in the fast axis direction.

Moreover, for many applications it is desirable for the sake of improving the beam quality, which also differs sharply in both directions, to homogenize the intensity distributions in one or both of these directions and to approximate the beam profile to a shape ranging from rectangular to line-shaped. In so doing, it must be taken into consideration that the intensity of an emitter of the diode laser bar in the fast axis direction corresponds in a first approximation to a Gaussian profile and has an approximately diffraction-limited beam quality, while the emitted radiation in the slow axis direction is highly unhomogeneous because of a multimode distribution due to the excitation of a maximum mode density which is carried out for reasons of efficiency. These characteristics are present in each of the beam bundles which are determined by the quantity, spacing and width of the emitters and which overlap, so that no homogeneous line beam source results from arranging emitters in rows in the plane of the active layer.

Arrangements and methods for homogenizing intensity distribution have already been described many times in the prior art. Optical arrangements according to U.S. Pat. No. 4,744,615 and U.S. Pat. No. 5,303,084 in which a light tunnel with plane, internally reflecting sides receives a divergent laser beam and overlaps it at the outlet of the light tunnel are known in particular.

However, light tunnels of the type mentioned above have a limited effect. This is true particularly when a beam bundle which proceeds from a line-shaped radiation source and which is unhomogeneous in the line direction is to be formed homogeneously with respect to radiation distribution over the entire cross section of a rectangular shape to be generated. This requirement and the requirement for high edge steepness are important, e.g., for laser welding, when a plurality of diode laser bars are to be arranged in a row for generating a continuous line-shaped beam cross section and the adjacent areas are to be free from interference in the intensity distribution. Radiation sources designed in the above manner are particularly advantageous when dispensing with movement of the tool for welding a long weld seam.

Homogenization with holographic gratings is also known, e.g., from U.S. Pat. No. 5,850,300; but this requires knowledge of the intensity distribution of the radiation source. Since diode laser bars, as three-dimensional objects, have different source points from which individual beam bundles overlapping in shape and intensity distribution are emitted, the total beam bundle formed in this way has a substantially undefined beam characteristic. For this reason, holographic gratings are not advantageous for beam homogenization with diode laser bars, especially since usually only conversion efficiencies in the range of 50% to 80% are achieved.

### OBJECT AND SUMMARY OF THE INVENTION

Therefore, it is the primary object of the invention to generate a working beam with different beam geometries, but preferably with a rectangular or line-shaped beam cross section, from overlapping laser beam bundles of a diode laser bar in a highly efficient manner using simple means, which working beam has an improved intensity distribution with respect to homogeneity and edge steepness and which ensures that a plurality of working beams can be arranged in rows for generating an elongated beam profile. A uniform intensity distribution which is free from interference should be present particularly in areas which adjoin one another.

This object is met in a laser radiation source of the type mentioned in the beginning in that reflection planes extending adjacent to one another in a direction vertical to the common plane of the active layers are provided between the side surfaces of the homogenization element, to which side surfaces the laser beam bundles are directed so as to overlap one another due to their divergence in the first coordinate direction, which reflection planes are traversed by the laser beam bundles one after the other and in which reflections are repeated due to the divergence of the laser beam bundles between the side surfaces in the first coordinate direction.

According to a preferred arrangement, reflection planes directed parallel to the common plane for the active layers are generated by a homogenization element whose side surfaces are directed vertical to the common plane of the active layers and at whose front sides reflecting deflecting surfaces which are inclined relative to the common plane of the active layers are provided as roof edge arrangements.

While one of the front sides is divided into an inlet area for the laser beam bundles, an area of the beam outlet and one of the roof edge arrangements, the other front side is used entirely to receive the other roof edge arrangement.

According to another preferred arrangement, reflecting surfaces are provided which are located across from one another and parallel to one another in pairs, the surfaces of a pair being directed vertical to the common plane of the active layers as side surfaces of a right parallelepiped. The surfaces of another pair are arranged, as end face parts of the right parallelepiped, so as to be inclined, diverging from the vertical, relative to the common plane of the active layers. Radiation-transparent areas which are provided in the end faces and are adjacent to the reflecting end face parts serve as radiation inlet and radiation outlet. The radiation inlet and the radiation outlet can be provided at the same end face or are distributed on both end faces.

In both arrangements, the reflecting side surfaces of the homogenization element are constructed as plane surfaces. However, if the divergence of the laser beam bundles is to be changed in the first direction, the reflecting side surfaces of the homogenization element can also be constructed as curved surfaces.

It is particularly advantageous when the inlet area for the laser beam bundles is extended in the first coordinate direction at least over the extent of the radiation field of the laser diode arrangement.

It is further advantageous for use of the described arrangements when imaging optics which are exchangeable in modular manner and which permit imaging oriented at various working distances and various beam geometries of the working beam are provided for imaging a homogenized beam cross section in a work plane.

A particularly positive effect on the results of the homogenization is brought about by the guidance of the semiconductor laser beam which is carried out repeatedly by the shortest path in the first coordinate direction by the repetition in that there is a working beam with a homogeneous intensity distribution extending over a substantially rectangular cross section at the outlet surface of the homogenization element. Beyond this, the invention permits a simultaneous modification of overlapping divergent individual beams of an arrangement of spatially separate, individual emitters with a compact optical component of simple construction which can be produced economically and is simple to adjust.

Since the rectangular beam cross section has well-defined beam parameters due to its homogeneous intensity distribution, it can be further processed especially well by imaging optical devices and can accordingly be adapted in a flexible manner to various application requirements and application purposes, e.g., the generation of line-shaped weld connections and solder connections, particularly with plastics and metals as well as for exposure purposes.

In particular, projection with lens combinations allows a line focus to be generated with line lengths which are freely definable within wide limits and a high edge steepness at a defined working distance, so that a sharply defined line can be generated on a workpiece. A working beam of this kind is particularly advantageous, e.g., for stationary welding of a longer weld seam, i.e., without requiring relative movement between the tool and the workpiece. The tool and workpiece can remain stationary. Auxiliary optical means for beam movement are not required. Further, the high edge steepness in the first coordinate direction and the homogeneous intensity distribution extending up to the edge of the working beam guarantees that working beams of a plurality of laser radiation sources according to the invention can be arranged in rows in modular fashion, so that the line length can be increased beyond the dimensions determined by the limited extent of the diode laser. The especially homogeneous intensity distribution provides weld seams of high quality, for example, because inadequate welding and burnt locations can be prevented.

The invention will be described more fully in the following with reference to the schematic drawings.

### BRIEF DESCRIPTION OF THE DRAWINGS

In the drawings:

FIG. 1 shows a laser radiation source with a prismatic homogenization element in a perspective view;

FIG. 2 shows a laser radiation source according to FIG. 1 in a side view with reflection planes adjacent to one another in the prismatic homogenization element;

FIG. 3 shows reflection planes adjacent to one another in a right-parallelepiped homogenization element arranged at an inclination in the beam path of the laser beam bundles;

FIG. 4 shows a right-parallelepiped homogenization element constructed as a hollow body;

FIG. 5 shows a graph depicting the intensity distribution before homogenization with the arrangement according to the invention;

FIG. 6 shows a graph illustrating the intensity distribution after homogenization with the arrangement according to the invention;

FIG. 7 shows the reflection in a reflection plane due to the divergence of the laser beam bundles in a coordinate direction, using the example of three laser beam bundles proceeding from individual emitters;

FIG. 8 shows the reflection in a reflection plane due to the divergence of a beam bundle in a coordinate direction from an emitter arranged at the edge of the diode laser; and

FIG. 9 shows the reflection in a reflection plane due to the divergence of a beam bundle in a coordinate direction from an emitter arranged in the center of the diode laser.

### DESCRIPTION OF THE PREFERRED EMBODIMENTS

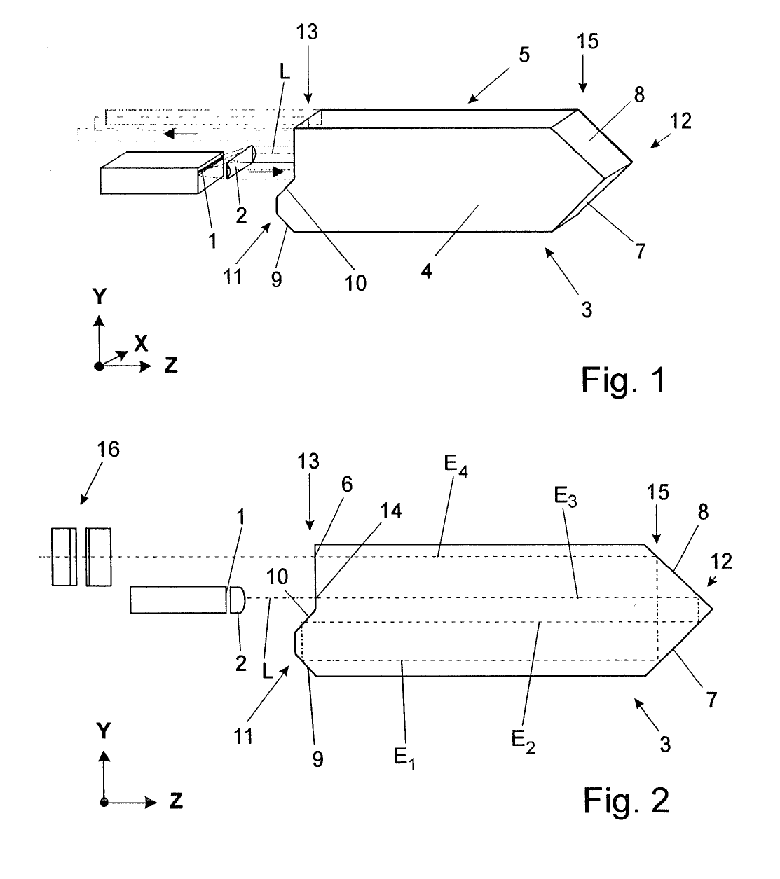

In the laser radiation source shown in FIG. 1, a diode laser bar is provided as laser diode arrangement 1. The emitter elements of the diode laser bar are arranged next to one another with their active layers in a common plane, in this case, the x-z plane, and so as to be spatially separate in a first coordinate direction (x-direction or slow axis). Fast axis collimating optics 2 act vertical to the active layers of the emitter elements and direct laser beam bundles L emitted by the emitter elements to a homogenization element 3 whose inlet area for the laser beam bundle L extends at least over the entire extension of the radiation field of the diode laser bar in the first coordinate direction. In this way, every emitter serving as radiation source point is detected optically, the beam parameter product remains the same and there is no deterioration in the diffraction characteristics. Since the divergence of the laser beam bundles L in the first coordinate direction is not eliminated, the laser radiation which enters with its entire width into the homogenization element 3 and which originates through mutual overlapping of the laser beam bundles L is repeatedly blended together, and accordingly homogenized, through reflection at a pair of plane reflecting side surfaces 4, 5 which face one another because of its divergent characteristic.

When curved surfaces are used instead of the plane side surfaces 4, 5, the divergence changes in the direction of the first coordinate corresponding to the curvature.

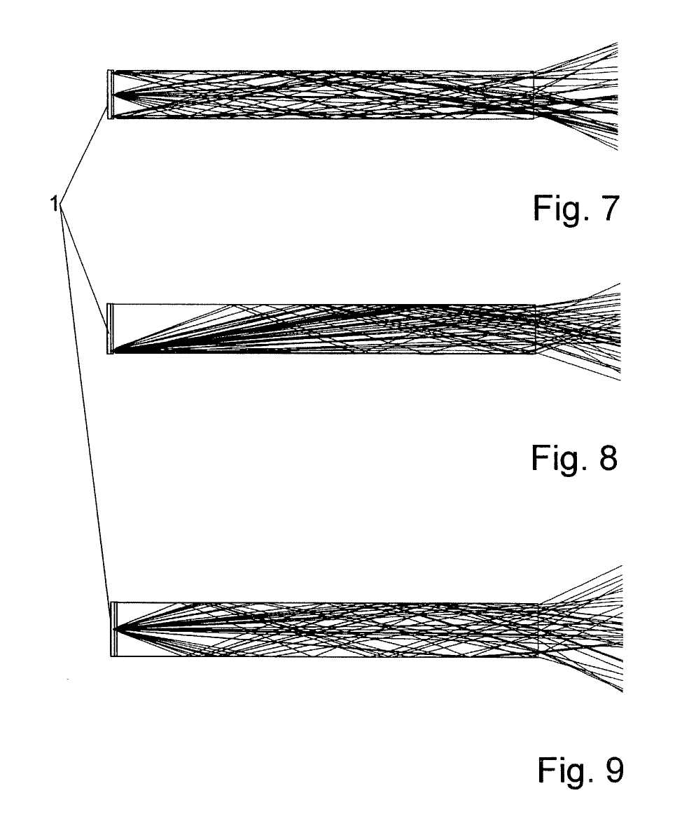

FIGS. 7 to 9 show the effect produced in the x-z plane for the laser beam bundles L by three emitters, by an emitter arranged at the edge, and by an emitter arranged in the center of the diode laser bar.

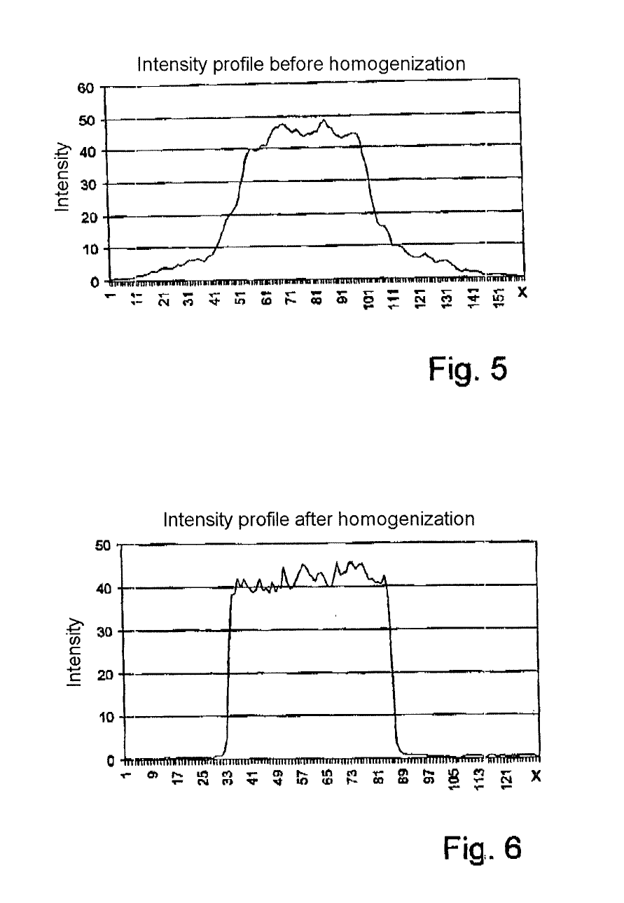

This effect of homogeneous distribution of the radiation intensity of every radiation source point is multiplied on an area of the beam outlet 6 in the homogenization element 3 in a particularly positive manner in that reflection planes E₁, E₂, E₃ and E₄ which are located adjacent to one another in a direction vertical to the common plane of the active layers are provided between the side surfaces 4, 5. The laser beam bundles L pass through these reflection planes E₁, E₂, E₃ and E₄ one after the other and the reflection between the side surfaces 4, 5 is repeated in the first coordinate direction in these reflection planes E₁, E₂, E₃ and E₄ (FIG. 2). In the embodiment example according to FIGS. 1 and 2, the reflection planes E₁, E₂, E₃ and E₄ which are adjacent to one another and, in this case, located one above the other are preferably generated as planes which are oriented parallel to the common plane for the active layers in that the homogenization element 3 has reflecting deflecting surfaces 7, 8, 9 and 10 as roof edge arrangements 11 and 12, respectively, which are inclined on the front side relative to the common plane of the active layers. While a first front side 13 of the homogenization element 3 is divided into an inlet area 14 for the laser beam bundles L, the area of the beam outlet 6 and an area for one roof edge arrangement 11, the second front side 15 located opposite the first front side 13 is completely available for the other roof edge arrangement 12. The intensity profile of a surface radiator extending in one direction or of a plurality of individual radiators arranged in a row with defined extension in the first coordinate direction and a radiating characteristic with any degree of inhomogeneity in this direction, as well as with a collimated radiating characteristic in a second direction vertical to the common plane of the active layers, is converted from that intensity profile existing prior to the homogenization according to FIG. 5 by the steps according to the invention in a surface radiator with high edge steepness at the edges of the intensity distribution, preferably in the first coordinate direction, and a particularly homogeneous intensity distribution over a rectangular intensity profile according to FIG. 6.

By means of imaging optics 16 for shaping the line width and line height, which imaging optics 16 are exchangeable in modular manner, the homogenized beam cross section in the area of the beam outlet 6, as virtual radiation source, together with the rest of the positive beam characteristics existing at that location, is projected in a work plane, not shown, so that a sharply defined line-shaped intensity distribution which is homogeneous and adjustable in width is formed. The projection is oriented to various work distances and various beam geometries and, of course, is therefore not limited only to line-shaped beam shapes, but can also generate rectangular or square beam shapes. Preferably, cross sections can also remain adjustable in which the height is approximately 1 mm and the other dimension remains adjustable by shortening or lengthening lines. This adjustability also ensures generation of a line focus in the work plane from the dimension of the housing width of the enclosed laser beam source, so that it is possible for laser beam sources enclosed in this way to be arranged in rows in a modular manner. Because of the high edge steepness of the intensity in the area of the beam outlet 6 in the direction of the first coordinate, line foci in which intensity peaks or intensity troughs are prevented are generated when the laser radiation sources are arranged in rows.

Other characteristics of the working beam, e.g., the position of the working plane, the line shape or the intensity distribution, can also be influenced depending on other constructions of the imaging optics 16.

Like the prismatic homogenization element 3, another embodiment form of the invention also acts with reflecting surfaces which are located across from one another in pairs parallel to one another. The surfaces of one of these pairs are directed vertical to the common plane of the active layers as side surfaces of a right parallelepiped 17 of optical glass, e.g., BK7. Only the side surface designated by 18 is shown. The other pair forms deflecting surfaces formed as end face parts 20, 21 with a reflective coating which are arranged so as to be offset relative to one another in a direction component vertical to the common plane of the active layers and inclined relative to this plane diverging from the vertical. Radiation-transparent areas for a beam inlet 22 and a beam outlet 23 are formed by the offset, these areas being located adjacent to one another at opposite sides.

Of course, it is also possible to provide the radiation-transparent area for the beam outlet 23 at the same end face as the area for the beam inlet 22. Both areas then adjoin the end face part 20 at opposite sides.

Reflection planes E₅ to E₁₁ which are adjacent to one another are generated by the inclination of the end face parts 20, 21 relative to the common plane of the active layers for the incident laser beam bundles L.

The laser beam bundles L entering the right parallelepiped 17 via the area 22 provided in the upper portion of one end face in the present example impinge on the other, oppositely located end face with oblique incidence on the reflecting partial area 21, from which a reflection is carried out on the oppositely located reflecting partial area 20. The reflection planes E₅ to E₁₁ extend in a zigzag pattern depending on the inclination of the reflecting partial areas 20, 21 relative to the common plane of the active layers, wherein the reflection planes E₅ to E₁₁ traversed by the laser beam bundles L in the same direction are directed parallel to one another. The reflections and back-reflections are carried out until the laser beam bundles L impinge on the area of the beam outlet 23 located in the other end face in the lower portion. Radiation characteristics similar to those in the area of the beam outlet 6 in the first embodiment example are present in area 23, so that the imaging in the work plane can be carried out proceeding from this area. When the beam inlet and beam outlet are located on the same front side, the beam outlet can be placed, e.g., where the reflection plane E₁₀ intersects the front side at which the beam inlet is located.

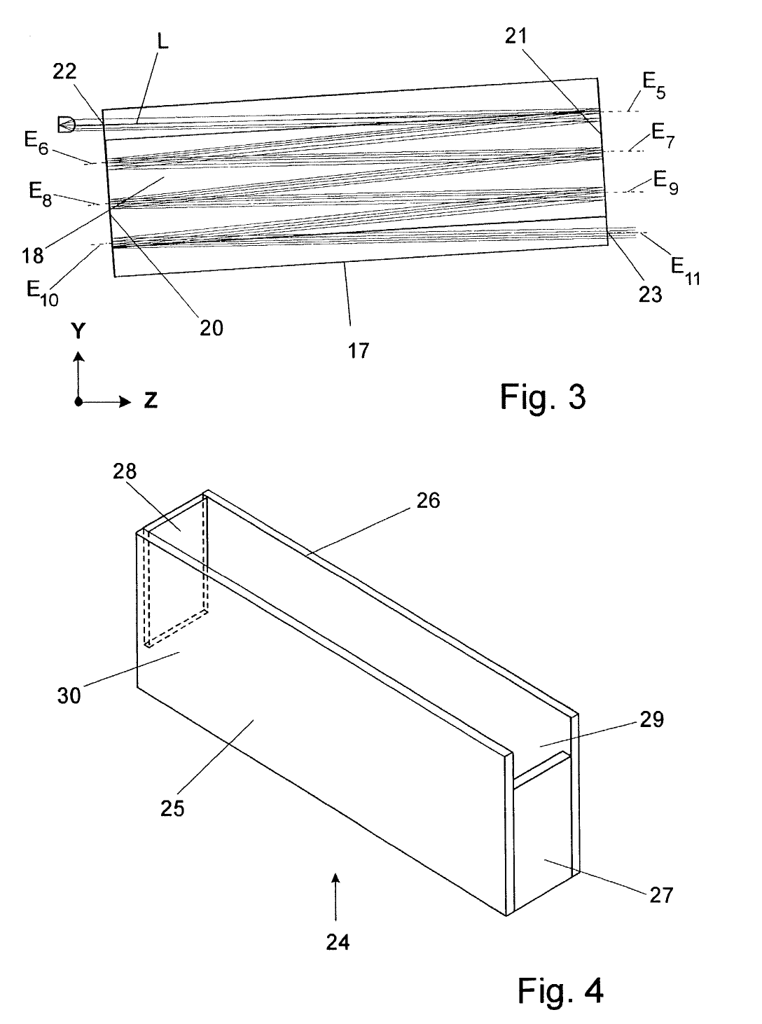

Of course, it is also possible for the homogenization element which is constructed as a solid glass body to be designed as a hollow body and physical mirrors can be used instead of reflecting surface coatings. Accordingly, in an example according to FIG. 4, a hollow body 24 of the type mentioned above is outfitted with reflecting side mirrors 25, 26 facing one another for the reflections used for homogenization. Reflection planes adjacent to one another in a direction vertical to the common plane of the active layers are generated by additional mirrors 27, 28 at the front sides of the hollow body 24 in that the latter is arranged in the laser beam at an inclination relative to the common plane of the active layers and contains areas for the beam inlet 29 and beam outlet 30 at the front sides, as was already shown in FIG. 3 and described for the solution using the solid glass body.

The invention is not limited only to the homogenization of the radiation of individual emitters arranged in a row as in diode laser bars, but can also be applied in connection with semiconductor laser stacks (stacked arrangements of laser diode bars).

While the foregoing description and drawings represent the present invention, it will be obvious to those skilled in the art that various changes may be made therein without departing from the true spirit and scope of the present invention.

What is claimed is:

1. A laser radiation source for generating a working beam in which emitter elements of a laser diode arrangement which emit laser beam bundles are arranged adjacent to one another with their active layers in a common plane and spatially separated in a first coordinate direction, comprising:
collimating optics acting in a second coordinate direction vertical to the common plane of the active layers of the emitter elements; and
a homogenization element with a pair of reflecting side surfaces facing one another;
reflection planes extending adjacent to one another in a direction vertical to the common plane of the active layers are provided between the side surfaces of the homogenization element, to which side surfaces the laser beam bundles are directed so as to overlap one another due to their divergence in the first coordinate direction;
said reflection planes being traversed by the laser beam bundles one after the other and in which reflections are repeated due to the divergence of the laser beam bundles between the side surfaces in the first coordinate direction.

2. The laser radiation source according to claim 1, wherein the reflection planes are directed parallel to the common plane for the active layers.

3. The laser radiation source according to claim 2, wherein the homogenization element whose side surfaces are directed vertical to the common plane of the active layers has front sides for generating the reflection planes, and reflecting deflecting surfaces which are inclined relative to the common plane of the active layers are provided as roof edge arrangements at these front sides.

4. The laser radiation source according to claim 3, wherein one of the front sides is divided into an inlet area for the laser beam bundles, an area of the beam outlet and one of the roof edge arrangements, and wherein the other front side is used entirely to receive the other roof edge arrangement.

5. The laser radiation source according to claim 1, wherein reflecting surfaces are provided which are located across from one another and parallel to one another in pairs, the surfaces of a pair being directed vertical to the common plane of the active layers as side surfaces of a right parallelepiped, and the surfaces of another pair, as end face parts of the right parallelepiped, are inclined, diverging from the vertical, relative to the common plane of the active layers, and wherein at least one of the end faces contains radiation-transparent areas for the radiation inlet and/or radiation outlet.

6. The laser radiation source according to claim 1, wherein imaging optics which are exchangeable in modular manner and which permit imaging oriented at various working distances and various beam geometries of the working beam are provided for imaging a homogenized beam cross section in a work plane.

7. The laser radiation source according to claim 6, wherein a plurality of working beams are arranged next to one another in the direction of the first coordinate in the work plane.

8. The laser radiation source according to claim 1, wherein the laser diode arrangement has a radiation field over which the inlet area for the laser beam bundles extends in the first coordinate direction.

9. The laser radiation source according to claim 1, wherein the reflecting side surfaces of the homogenization element are constructed as plane surfaces.

10. The laser radiation source according to claim 1, wherein the reflecting side surfaces of the homogenization element are constructed as curved surfaces for changing the divergence in the first direction.
